(19) United States
(12) Patent Application Publication
(10) Pub. No.: US 2014/0372029 A1
(43) Pub. Date: Dec. 18, 2014

(54) Navigating and Routing Device

(71) Applicant: NOVATEK Microelectronics Corp., Hsin-Chu (TW)

(72) Inventor: Szu-Ying Huang, Taoyuan County (TW)

(73) Assignee: NOVATEK Microelectronics Corp., Hsin-Chu (TW)

(21) Appl. No.: 14/064,203

(22) Filed: Oct. 28, 2013

(30) Foreign Application Priority Data
Jun. 18, 2013 (TW) 102121611

(51) Int. Cl. G01C 21/34; G01C 21/36

(52) U.S. Cl. CPC G01C 21/34; G01C 21/36
USPC 701/526

(57) ABSTRACT

A navigating and routing device for a mobile device is disclosed. The navigating and routing device includes a setting unit, for setting a local device information of the navigating and routing device and at least one device information of at least one navigating and routing device of at least one mobile device; a positioning unit, for obtaining a local position information of the navigating and routing device and at least one positioning information of the at least one navigating and routing device via a positioning system according to the local device information and the at least one device information; and a navigating and routing unit, for navigating and routing a route from the mobile device to a target according to a position of the target and the local position information.

### BACKGROUND OF THE INVENTION

1. Field of the Invention

The present invention relates to a navigating and routing device, and more particularly, to a navigating and routing device for a mobile device, which provides a recommended route and information thereof so as to navigate a user to a destination according to information of the mobile device and other mobile devices, thereby increasing travel convenience and security.

2. Description of the Prior Art

Generally speaking, after a user specifies a destination, a conventional satellite navigation device for a car can provide a recommended route from the car to the destination, each position of the car during the navigation and information thereof so as to navigate the user to the destination according to the recommended route. If the car strays from the recommended route, the conventional satellite navigation device will recalculate and propose other appropriate routes so that the user can reach the destination as well.

In the case of group travel, especially when there are two or more than two cars, at least one car must follow another serving as the leading one. However, traffic, weather and other factors often make it difficult for one car to follow another one—and chances are that the following car gets lost. In other words, without good communication, following other's car often inconveniences the companions. In addition, driving can become dramatically dangerous.

However, since the conventional satellite navigation device for a car can merely provide a route from the car to a destination of a stationary location (e.g., a landmark and an address), each position of the car during the navigation and information thereof, its application is limited—for example, it is less applicable to the aforementioned case of following other's car. As a result, there is still room for improvement in the field.

### SUMMARY OF THE INVENTION

It is one of the objectives of the invention to provide a navigating and routing device for a mobile device, which provides a recommended route and information thereof so as to navigate a user to a destination according to information of the mobile device and other mobile devices, thereby increasing travel convenience and security.

A navigating and routing device for a mobile device is disclosed in the present invention. The navigating and routing device includes a setting unit, a positioning unit and a navigating and routing unit. The setting unit is for setting a local device information of the navigating and routing device and at least one device information of at least one navigating and routing device of at least one mobile device. The positioning unit is for obtaining a local position information of the navigating and routing device and at least one positioning information of the at least one navigating and routing device via a positioning system according to the local device information and the at least one device information. The navigating and routing unit is for navigating and routing a route from the mobile device to a target according to a position of the target and the local position information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a navigating and routing device according to an embodiment of the present invention.

FIG. 2 is a schematic diagram illustrating how to obtain device information according to the embodiment of the present invention.

FIG. 3 is a schematic diagram illustrating how a display unit shown in FIG. 2 displays the mobile device serving as a target mobile device.

### DETAILED DESCRIPTION

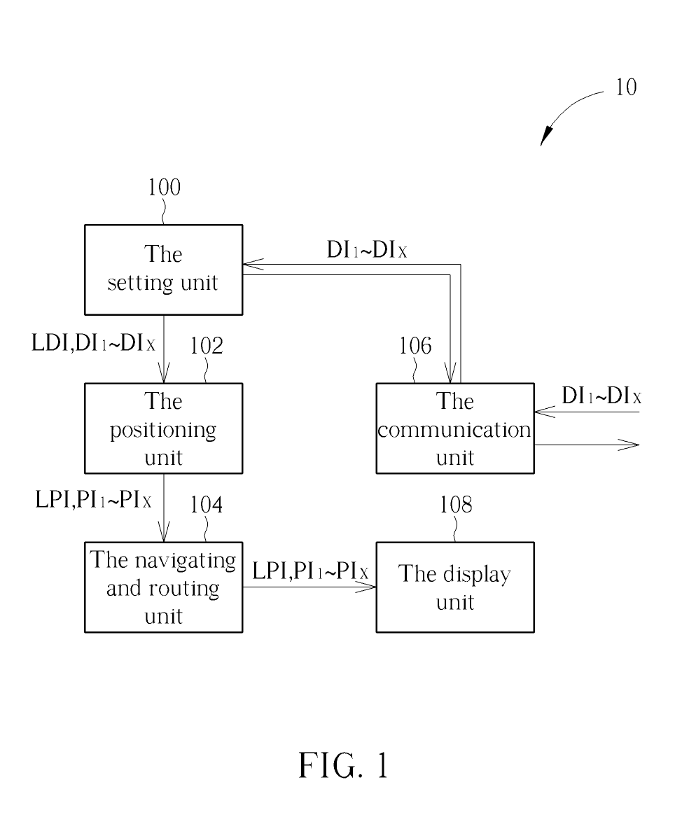

Please refer to FIG. 1. FIG. 1 is a schematic diagram illustrating a navigating and routing device 10 according to an embodiment of the present invention. As shown in FIG. 1, the navigating and routing device 10 comprises a setting unit 100, a positioning unit 102 and a navigating and routing unit 104. In short, the navigating and routing device 10 is utilized in a mobile device LMD, such as a car or other mobile devices. When a user attempts to set the mobile device LMD and the mobile devices MD₁, . . . , MDₓ into one group, the setting unit 100 can set a local device information LDI of the navigating and routing device 10 and the device information DI₁, . . . , DIₓ of the navigating and routing devices NRD₁, . . . , NRDₓ of the mobile devices MD₁, . . . , MDₓ such that the positioning unit 102 can obtain a local position information LPI (i.e., the position information of the mobile device LMD) of the navigating and routing device 10 and the position information PI₁, . . . , PIₓ (i.e., the position information of the mobile devices MD₁, . . . , MDₓ) of the navigating and routing devices NRD₁, . . . , NRDₓ via a positioning system PS according to the local device information LDI and the device information DI₁, . . . , DIₓ and subsequently send the local position information LPI and the position information PI₁, . . . , PIₓ to the navigating and routing unit 104. Therefore, the navigating and routing unit 104 can navigate and route a route from the mobile device LMD to a target T according to a position of the target T and the local position information LPI. In this case, the positioning system PS can be various positioning systems, such as the Global Position System (GPS) and Assisted Global Positioning System (AGPS). As a result, the navigating and routing device 10 can provide a recommended route and information thereof so as to navigate the user to the destination according to the position information PI₁, . . . , PIₓ of the mobile devices MD₁, . . . , MDₓ and the local position information LPI of the mobile device LMD, thereby improving the flexibility and increasing travel convenience and security.

Furthermore, the navigating and routing device 10 may further comprise a communication unit 106 and a display unit 108. When the user attempts to set the mobile device LMD and the mobile devices MD₁, . . . , MDₓ into one group, the communication unit 106 corresponding to the navigating and routing device 10 first performs authentication—for example, a password is requested and the authentication succeeds only if the password in reply is correct—with the communication units CU₁, . . . , CUₓ corresponding to the navigating and routing devices NRD₁, . . . , NRDₓ of the mobile devices MD₁, . . . , MDₓ via wireless or wired communication, such as Bluetooth, 3G wireless internet and Wi-Fi, so as to obtain the device information DI₁, . . . , DIₓ of the navigating and routing devices NRD₁, . . . , NRDₓ and subsequently send the device information DI₁, . . . , DIₓ to the setting unit 100. Accordingly, the setting unit 100 can set the local device information LDI and the device information DI₁, . . . , DIₓ so that the positioning unit 102 can obtain the local position information LPI and the position information PI₁, . . . , PIₓ, and the display unit 108 subsequently displays at least one of the mobile devices MD₁, . . . , MDₓ on a map according to the local position information LPI and the position information PI₁, . . . , PIₓ.

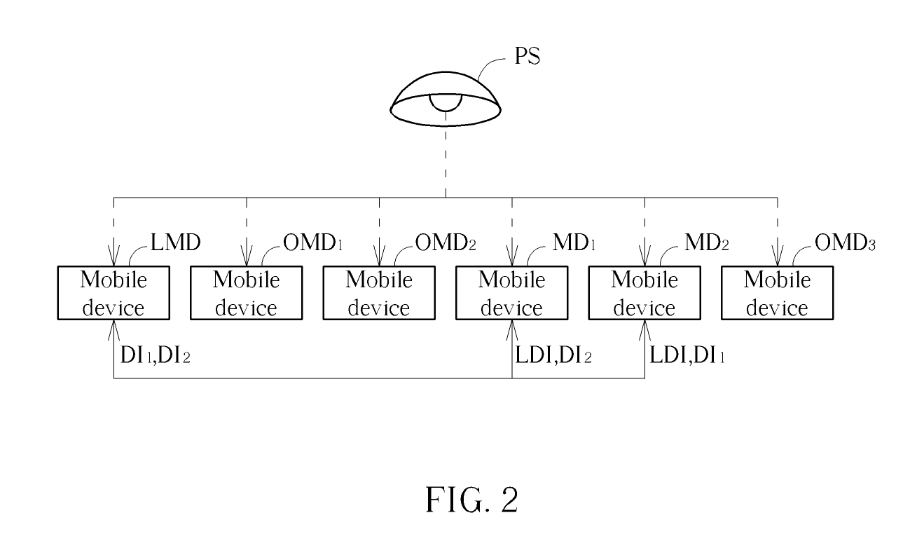

For example, please refer to FIG. 2. FIG. 2 is a schematic diagram illustrating how to obtain the device information DI₁, . . . , DI₂ according to the embodiment of the present invention. As shown in FIG. 2, there are the mobile devices MD₁, . . . , MD₂ and the mobile devices OMD₁, . . . , OMD₃, which also navigate with the positioning system PS, around the mobile device LMD with the navigating and routing device 10. When the user attempts to set the mobile device LMD and the mobile devices MD₁, . . . , MDₓ into one group, the communication unit 106 can obtain the device information DI₁, . . . , DI₂ after completing authentication with the communication units CU₁, . . . , CU₂ corresponding to the navigating and routing devices NRD₁, . . . , NRDₓ of the mobile devices MD₁, . . . , MDₓ such that the display unit 108 can subsequently display at least one of the mobile devices MD₁, . . . , MDₓ on the map. At the same time, the communication units CU₁, . . . , CU₂ can also obtain the local device information LDI such that each of the display units can respectively display the mobile device LMD on the map.

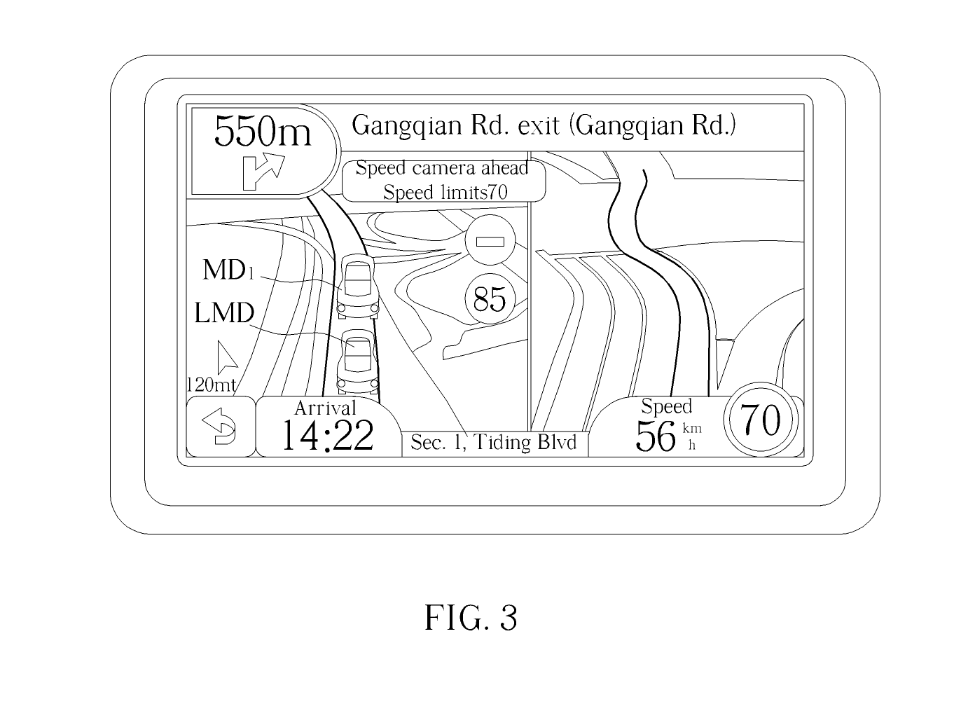

In such a condition, please refer to FIG. 3. FIG. 3 is a schematic diagram illustrating how the display unit 108 shown in FIG. 2 displays the mobile device MD₁ serving as a target mobile device. As shown in FIG. 3, when the setting unit 100 sets the target T as the target mobile device MD₁, the navigating and routing unit 104 navigates and routes the route from the mobile device LMD to the mobile device MD₁ according to the target position information PI₁ of the mobile device MD₁ and the local position information LPI. Namely, the mobile device MD₁ leads the mobile device LMD as a leading device. In such a situation, when the mobile device LMD is far behind the mobile device MD₁, the mobile device LMD can move according to the navigated route. When the mobile device LMD is in front of the mobile device MD₁, the mobile device LMD can slow down properly for the mobile device MD₁ to catch up so that the mobile device LMD moves after the mobile device MD₁ again. As a result, the navigating and routing device 10 can set the mobile device MD₁ as the leading device, and the planned route varies with the position of the leading device to avoiding getting lost. Therefore, it is not limited to the route from the user to a destination of a stationary location, which overcomes the drawback of the conventional techniques for following other's car and increases travel convenience and security.

It is worth noting that, in the spirit of the above-mentioned embodiment, the navigating and routing device 10 can provide a recommended route and information thereof so as to navigate the user to the destination according to the position information PI₁, . . . , PIₓ of the mobile devices MD₁, . . . , MDₓ and the local position information LPI of the mobile device LMD, thereby improving the flexibility and increasing travel convenience and security. However, the present invention is not limited thereto, and those skilled in the art might make modifications or alterations accordingly. For example, in the aforementioned embodiment, the navigating and routing device 10 provides a notification if the distance between the mobile device MD₁ serving as the leading device and the mobile device LMD is greater than a predetermined distance—for example, if the distance between the mobile device MD₁ and the mobile device LMD is more than kilometers, the display unit 108 issues notifications and alternatively the navigating and routing device 10 sends voice notifications—such that the mobile device LMD can speedup to catch up the mobile device MD₁. Besides, in the above-mentioned embodiment, the navigating and routing device 10 sets the mobile device MD₁ as the target mobile device. Nevertheless, in other embodiments, the mobile device LMD corresponding to the navigating and routing device 10 may also be set as a target mobile device by other mobile devices, which may be called as the following mobile devices. The navigating and routing device 10 may provide a notification if the distance between the following mobile device and the mobile device LMD is greater than a predetermined distance such that the mobile device LMD can slow down for the following mobile device to catch up.

Moreover, when the setting unit 100 sets the target T as the target mobile device MD₁, the navigating and routing unit 104 can navigate and route not only a shortest path from the mobile device LMD to the mobile device MD₁ (i.e., the target T) but also a movement path of the mobile device MD₁. For example, if the mobile device LMD stops for some reason and then moves on, the navigating and routing unit 104 can navigate and route the shortest path from the mobile device LMD to the mobile device MD₁ so as to catch up the mobile device MD₁. Alternatively, the navigating and routing unit 104 can also navigate and route the movement path of the mobile device MD₁ so that the mobile device LMD follows the exact movement path of the mobile device MD₁ serving as the leading device. In addition, the mobile device LMD and the mobile devices MD₁, . . . , MDₓ can all set a specific mobile device as the target mobile device (i.e., the target T), and, in this case, the specific mobile device can set a destination of a stationary location as its target. Alternatively, the mobile device LMD and the mobile devices MD₁, . . . , MDₓ may line up in order, and each, in turn, sets the mobile device in front as the target mobile device. However, the present invention is not limited to these, and other methods of setting the target mobile device may be applied as well.

In the prior art, since a conventional satellite navigation device for a car can merely provide a route from the car to a destination of a stationary location (e.g., a landmark and an address), each position of the car during the navigation and information thereof, its application is limited—for example, it is less applicable to cases of following other's car. In comparison, the navigating and routing device 10 can provide a recommended route and information thereof so as to navigate the user to the destination according to the position information PI₁, . . . , PIₓ of the mobile devices MD₁, . . . , MDₓ and the local position information LPI of the mobile device LMD, thereby improving the flexibility and increasing travel convenience and security.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A navigating and routing device for a mobile device, the navigating and routing device comprising:
a setting unit, for setting a local device information of the navigating and routing device and at least one device information of at least one navigating and routing device of at least one mobile device;
a positioning unit, for obtaining a local position information of the navigating and routing device and at least one position information of the at least one navigating and routing device via a positioning system according to the local device information and the at least one non-local device information; and
a navigating and routing unit, for navigating and routing a route from the mobile device to a target according to a position of the target and the local position information.

2. The navigating and routing device of claim 1, wherein a communication unit corresponding to the navigating and routing device performs authentication with at least one communication unit corresponding to the at least one navigating and routing device of the at least one mobile device to obtain the at least one device information of the at least one navigating and routing device.

3. The navigating and routing device of claim 1, wherein the navigating and routing device further comprises a display unit for displaying at least one of the at least one mobile device according to the at least one position information.

4. The navigating and routing device of claim 1, wherein the setting unit sets the target as a target mobile device among the at least one mobile device, and the navigating and routing unit navigates and routes the route from the mobile device to the target mobile device according to a target position information of the target mobile device and the local position information.

5. The navigating and routing device of claim 4, wherein the navigating and routing device provides a notification if a distance between the target mobile device and the mobile device is greater than a predetermined distance.

6. The navigating and routing device of claim 1, wherein a following mobile device among the at least one mobile device sets the mobile device as a target mobile device, and the navigating and routing device provides a notification if a distance between the following mobile device and the mobile device is greater than a predetermined distance.

7. The navigating and routing device of claim 1, wherein the navigating and routing unit navigates and routes a shortest path from the mobile device to the target.

8. The navigating and routing device of claim 4, wherein the navigating and routing unit navigates and routes a movement path of the target mobile device.
